(19) United States
(12) Patent Application Publication
(10) Pub. No.: US 2025/0284615 A1
(43) Pub. Date: Sep. 11, 2025

(54) SYSTEM DEBUGGING USING A COPY AND REAL-TIME DATA OF THE SYSTEM

(71) Applicant: INTERNATIONAL BUSINESS MACHINES CORPORATION, Armonk, NY (US)

(72) Inventors: Girish CHHABRA, San Jose, CA (US); Bhavesh SAINI, Staten Island, NY (US); Laura SALCIDO, San Jose, CA (US); Matthias SEUL, Folsom, CA (US)

(21) Appl. No.: 18/597,412

(22) Filed: Mar. 6, 2024

(51) Int. Cl. G06F 11/36; G06F 9/455; G06F 21/60; G06F 21/62

(52) U.S. Cl. CPC G06F 11/362; G06F 9/45558; G06F 21/604; G06F 21/6254; G06F 2009/45562

(57) ABSTRACT

A copy of a system is created within a selected region. The selected region is different from a region that includes the system and is obtained for the copy of the system based on one or more privileges of a support agent to be used to debug the system. Real-time data of the system is obtained at the copy of the system. The real-time data is migrated from the system to the copy of the system. The copy of the system and the real-time data migrated from the system is to be used to debug the system. Debugging processing using the copy of the system and the real-time data migrated from the system is performed to generate a debug solution for the system. The debug solution is provided to a selected entity.

### BACKGROUND

One or more aspects relate, in general, to processing within a computing environment, and in particular, to debugging systems of the computing environment.

If a system has an issue (e.g., down, unexpected condition, unexpected result, error, etc.), an on-call support agent (e.g., an on-call engineer) may need access to certain resources to resolve the system issue. Each resource grants the on-call support agent a different level of access based on access privileges of the on-call support agent. This provides security for the system, preventing data from being inappropriately accessed.

The obtaining of the required security accesses may be time-consuming, however, which may lead to further issues for the system.

### SUMMARY

Shortcomings of the prior art are overcome, and additional advantages are provided through the provision of a computer-implemented method of facilitating processing within a computing environment. The computer-implemented method includes creating a copy of a system within a selected region. The selected region is different from a region that includes the system, and the selected region is obtained for the copy of the system based on one or more privileges of a support agent to be used to debug the system. Real-time data of the system is obtained at the copy of the system. The real-time data is migrated from the system to the copy of the system. The copy of the system and the real-time data migrated from the system is to be used to debug the system. Debugging processing using the copy of the system and the real-time data migrated from the system is performed to generate a debug solution for the system. The debug solution is provided to a selected entity.

Computer-implemented methods, computer systems and computer program products relating to one or more aspects are described and claimed herein. Each of the embodiments of the computer-implemented method may be embodiments of each computer system and/or each computer program product and vice-versa. Further, each of the embodiments is separable and optional from one another. Moreover, embodiments may be combined with one another. Each of the embodiments of the computer-implemented method may be combinable with aspects and/or embodiments of each computer system and/or computer program product, and vice-versa. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate and use one or more aspects of the present disclosure;

FIG. 2 depicts one example of creating a new system context from an existing system context, in accordance with one or more aspects of the present disclosure;

FIG. 3 depicts one example of a debug module used in accordance with one or more aspects of the present disclosure;

FIG. 4 depicts one example of a debug process, in accordance with one or more aspects of the present disclosure;

FIG. 5 depicts one example of further details of a debug process, in accordance with one or more aspects of the present disclosure;

FIG. 6 depicts one example of a debug architecture used in accordance with one or more aspects of the present disclosure; and

FIGS. 7A-7B depict another example of a computing environment to incorporate and use one or more aspects of the present disclosure.

### DETAILED DESCRIPTION

In accordance with one or more aspects of the present disclosure, a capability is provided to facilitate processing within a computing environment. In one or more aspects, the capability includes debugging a system that is experiencing an issue (e.g., down, unexpected condition, unexpected result, error, etc.). The system is, for instance, a virtual machine, a container or other type of system. In one example, the system is a production system; e.g., a system executing in a production environment rather than a test system in a test environment.

In one or more aspects, the debugging includes creating a copy of the system to be debugged. The copy is created from a snapshot of the system. The copy may be a clone, a digital twin, a replica or other type of copy. In one example, the copy is created in a region accessible to a support agent, such as an on-call support agent, to be used in performing the debugging. The on-call support agent automatically has access to this region and the copy of the system without requesting access and/or permissions. Traffic, such as real-time data (also referred to as live data) of the system to be debugged, is mirrored to the copy of the system such that the copy of the system is updated in real-time and not a stale snapshot. Interaction between the system being debugged and the copy of the system is handled by a response simulator, in one example, to prevent the copy of the system from communicating back to the system being debugged or the internet. Information flow between the system being debugged and the copy of the system is unidirectional from the system being debugged to the copy of the system.

In one or more aspects, the copy of the system and the real-time data migrated to the copy are used by, e.g., the on-call support agent in debugging the issue and generating a solution. The solution is provided, in one example, to the system being debugged. In one or more aspects, the system executes using the solution. Determinations are made as to whether the solution is successful. These determinations may be made using benchmarks, tests, thresholds, etc. If the solution is successful, then no further debugging is performed. Otherwise, additional debugging is performed. This additional debugging may use the copy of the system or create a new copy of the system. Many variations are possible.

In accordance with one or more aspects, wait times to receive access by the support agent to the system experiencing issues is eliminated (or significantly reduced). Instead, the debugging is performed on the copy of the system and the real-time data mirrored from the system to the copy. This facilitates debugging and improves performance of the system being debugged. Since a copy is used with real-time data, and the debugging is not performed on the actual system being debugged, debugging is easier and more robust testing may be performed without concerns of negatively affecting the system being debugged during the debugging. This enables the issue to be resolved quicker, allowing processing within the system being debugged to be improved.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that performs, e.g., debug processing and/or one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

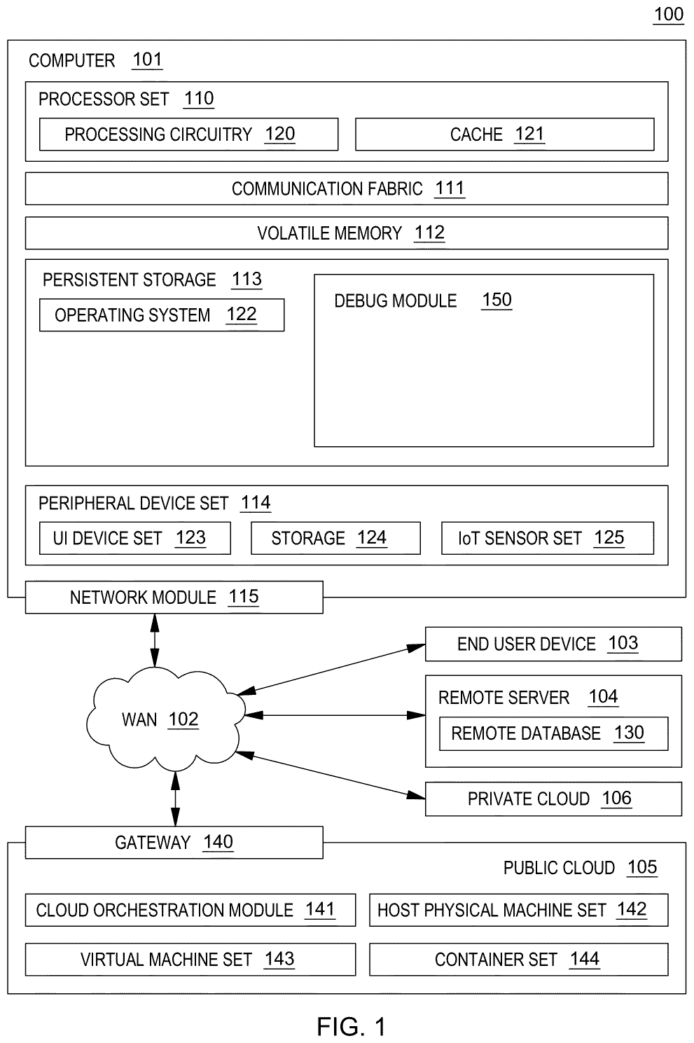

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as logic device debug code or module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

In accordance with one or more aspects of the present disclosure, a capability is provided to debug systems. In one or more aspects, the debug capability includes creating a copy of the system to be debugged, such that the debugging of the system is performed in the background (i.e., not at the system itself). Although the debugging is performed at the copy of the system, the debugging uses real-time traffic mirrored from the system being debugged to the copy of the system to provide a real-world view of the issue the system is experiencing.

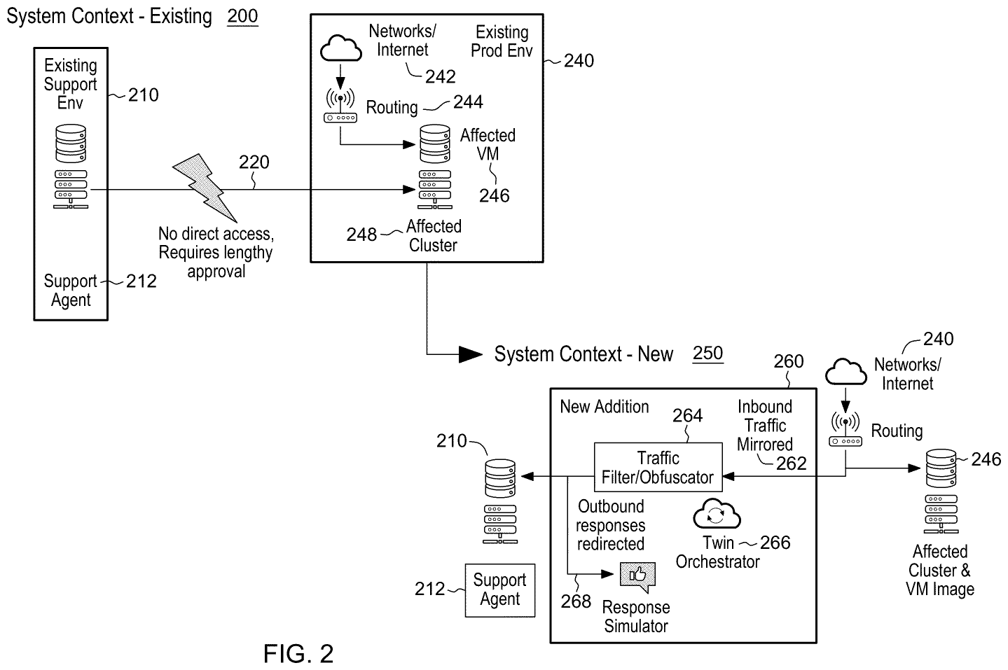

In one or more aspects, to create and use a copy of the system, a new system context is created based on an existing system context. One example of creating the new system context is described with reference to FIG. 2. As depicted, in one example, an existing system context 200 includes an existing support environment 210 that has one or more support agents 212 (e.g., one or more on-call support agents). In this context, at least one of the support agents 212 does not have direct access 220 to an existing production environment 240. Therefore, to access existing production environment 240, support agent 212 is to go through an approval process, which may be lengthy, to access the production environment (e.g., existing production environment 240).

In one example, the existing production environment (e.g., existing production environment 240) includes one or more networks/internet 242 that provide traffic (e.g., queries, requests, instructions, commands, etc.), which is routed 244 to a system, such as a virtual machine 246. In one example, this system (e.g., virtual machine 246) is experiencing an issue, and therefore, is referred to as an affected virtual machine, an affected system, a faulty system or a system to be debugged, as examples. The affected virtual machine may be part of and/or coupled to an affected cluster 248. The affected virtual machine is not directly accessible, in this example, to support agent 212. Instead, to access the affected virtual machine, support agent 212 is to go through an approval process.

However, in accordance with one or more aspects, rather than using the approval process, a new system context 250 is obtained (e.g., created, provided, employed, etc.), which is used by a support agent (e.g., support agent 212) to debug the affected system (e.g., affected virtual machine 246). In one example, new system context 250 is automatically obtained based on a determination that the support agent does not have access to the system without going through an approval process (referred to herein as the system is inaccessible to the support agent). The new system context includes, for instance, an existing support environment (e.g., existing support environment 210) that is coupled to an existing production environment (e.g., existing production environment 240) via, e.g., a system unit 260 obtained based on the inaccessibility of the system to the support agent (e.g., support agent 212) and is based on the support agent's access privileges (e.g., privileges, credentials, etc.).

In one example, system unit 260 is created within a cloud environment, such as a virtual private cloud environment hosted within, e.g., a public cloud (e.g., public cloud 105) and distributed across one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 and/or other processor(s) or node(s); processing circuitry, such as processing circuitry 120 of processor set 110 and/or other processing circuitry; and/or other computing devices, etc.). Other examples are possible including, for instance, creating the system unit within other environments, including non-cloud environments. Many examples are possible.

In one example, system unit 260 includes inbound mirrored traffic 262 received from existing production environment 240 (this same traffic is routed to the affected system (e.g., affected virtual machine 246); a traffic filter/obfuscator 264 to obfuscate the mirrored traffic based on access privileges of the support agent to be used to debug the system (e.g., affected virtual machine 246); a twin orchestrator 266 to create a copy of the affected system, which is used in debugging the affected system; and outbound redirected responses 268 to be used in debugging the affected system. In one or more aspects, system unit 260 is used to debug a system (e.g., affected virtual machine 246) absent an approval process and/or permission to access the existing production environment 240 and without concern of modifying the affected virtual machine while debugging. System unit 260 is accessible to the support agent, without an approval process, and may include one or more other modules or services.

To create at least the copy of the system within the system unit (e.g., system unit 260) and perform debugging, in one example, a debug module (e.g., debug module 150) is used, in accordance with one or more aspects of the present disclosure. A debug module (e.g., debug module 150) includes code or instructions used to create the at least part of the system unit and perform debug processing and/or other processing, in accordance with one or more aspects of the present disclosure. A debug module (e.g., debug module 150) includes, in one example, various sub-modules to be used to create the at least the copy of the system and perform debug processing and/or other processing of one or more aspects of the present disclosure. The sub-modules are, e.g., computer readable program code (e.g., instructions) in computer readable storage media, e.g., storage (persistent storage 113, cache 121, storage 124, other storage, as examples). The computer readable storage media may be part of one or more computer program products and the computer readable program code may be executed by and/or using one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute one or more of the sub-modules and/or portions thereof. Many examples are possible.

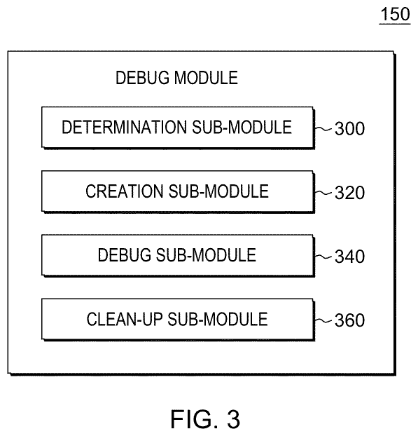

One example of debug module 150 is described with reference to FIG. 3. In one example, debug module 150 includes, for instance, a determination sub-module 300 to be used to determine a system is experiencing an issue to which a debug solution is to be provided; a creation sub-module 320 to be used to create, at least, a copy of the affected system to be used in debugging to provide the debug solution; a debug sub-module 340 to be used to employ the copy of the affected system to provide the debug solution; and a clean-up sub-module 360 to be used to clean-up the created copy subsequent to generating and/or providing the debug solution. Debug module 150 may include additional, fewer and/or other sub-modules. Many variations are possible. Further, similar modules/sub-modules may be used for other selected purposes. In one or more aspects, one or more sub-modules may be executed by different system contexts. For instance, one or more of the sub-modules may be executed by/for an existing system context and one or more of the sub-modules may be executed by/for a new system context. Other examples are possible.

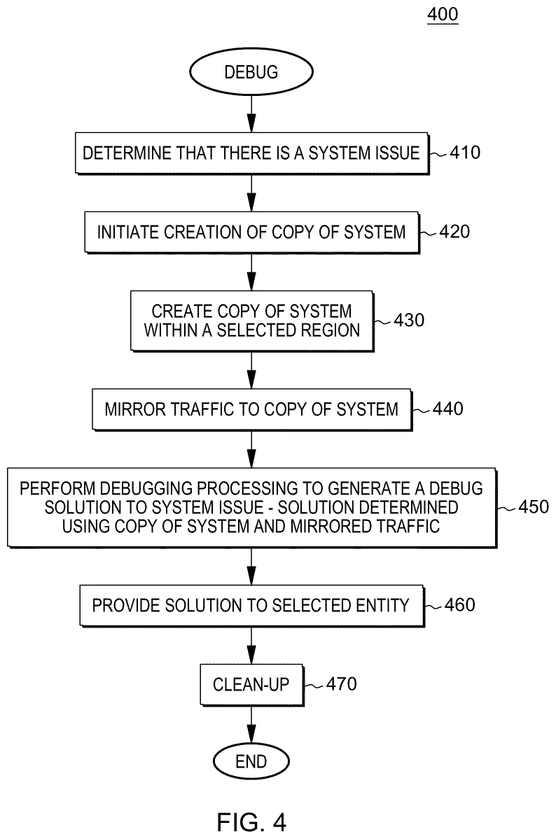

In one or more aspects, one or more of the sub-modules (e.g., sub-modules 300-360) are used by a debug process to create a copy of the system to be debugged (and/or a system unit) and to perform debugging using the copy of the system. One example of a debug process is described with reference to FIG. 4. In one example, a debug process 400 may be executed by and/or using one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute the process and/or other aspects of the present disclosure. Many examples are possible.

Referring to FIG. 4, in one example, debug process 400 (also referred to as process 400) determines 410 that a system (e.g., a virtual machine, a container, another system, etc.) has an issue (e.g., down, unexpected condition, unexpected result, error, etc.). This is determined based, for instance, on one or more logs generated by the system and/or monitoring protocols.

Based on determining the system is experiencing an issue, in one example, process 400 initiates creation 420 of a copy of the system. In one example, process 400 initiates creation of the copy of the system based on obtaining a notification that the system is to be copied. In one example, this notification is performed based on inaccessibility of the system to the support agent.

In one example, process 400 creates 430 the copy of the system within a selected environment within a selected region. As an example, the selected environment is a cloud environment, such as a virtual private cloud environment, at the selected region that is different from the environment in which the system is executing. Therefore, the creating the copy includes obtaining (e.g., creating, being provided, employing, etc.) the selected environment at the selected region, which is based on access privileges of the support agent; obtaining (e.g., creating, being provided, employing, etc.) a system unit (e.g., system unit 260) in the environment; and creating using one or more units, modules and/or services of the system unit a copy of the system.

In one example, process 400 mirrors 440 traffic from the system to be debugged to the copy of the system. The traffic is, for instance, real-time traffic (e.g., queries, requests, instructions, commands, etc.) at the system to be debugged that is mirrored (e.g., copied, replicated, etc.) to the copy of the system.

Process 400 performs 450 debugging processing to generate a debug solution to the system issue. The debugging processing includes, e.g., receiving mirrored traffic, performing processing at the system copy using the mirrored traffic (e.g., execute commands, execute instructions, perform queries, respond to requests, etc.), simulating results/responses based on the processing, examining the results, making changes (e.g., to the code, sequencing, timing, etc.), testing the changes, etc. In one example, an on-call support agent uses the copy of the system and the mirrored traffic in debugging the system (e.g., control and/or perform part of the debug processing). The support agent may be a person and/or an agent based on computing, such as an artificial intelligence agent or other type of agent based on computing and/or artificial intelligence.

Process 400 provides 460 the debug solution to a selected entity that further provides the debug solution to the system. For instance, the debug solution is provided to the on-call agent, a module, a unit or a service that provides the debug solution to the affected system. In one example, the affected system implements the debug solution. Logs are maintained, and based thereon, a determination may be made as to whether the debug solution solved the issue. If not, further debugging is performed. This may include using the created copy or a new copy of the system and additional mirrored traffic. Other examples are possible.

In one example, based on providing the solution to the system, process 400 cleans-up 470 the copy. For example, the copy of the system is deleted, and the mirroring is terminated. Other examples are possible.

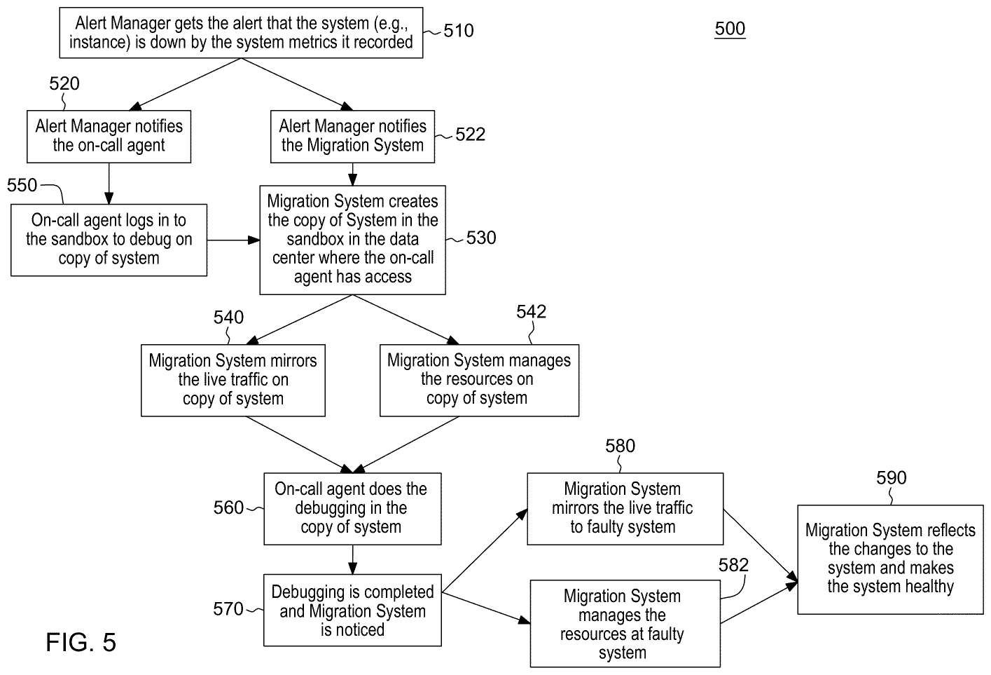

Further details of one example of debugging a system are described with reference to FIG. 5. In one example, a debug process 500 may be executed by and/or using one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute the process and/or other aspects of the present disclosure. Many examples are possible.

Referring to FIG. 5, in one example, debug process 500 (also referred to as process 500) obtains 510, via, e.g., an alert manager, an alert indicating that the system (e.g., a virtual machine, a container, other system) is experiencing an issue (e.g., down, unexpected condition, unexpected result, error, etc.). This alert is based, for instance, on metrics (e.g., performance, error logs, other metrics) obtained (e.g., provided, recorded, observed, retrieved, etc.) by the alert manager. In one example, a monitoring unit is used to monitor the health of the system and based on detecting an issue the monitoring unit notifies an alert agent. The alert agent may be a part of or coupled to the monitoring unit. It may be part of another unit coupled to the monitoring unit. The monitoring unit may be hardware, software and/or a combination thereof. It may include sensor and/or other monitors, gauges, etc.

Based on obtaining the alert, process 500, via, e.g., the alert manager, notifies 520 a support agent, such as an on-call support agent (also referred to herein as on-call agent; e.g., an on-call support person (e.g., an on-call engineer, on-call analyst, etc.), an on-call compute agent (e.g., an artificial intelligence agent), etc.) and notifies 522 a migration system of the alert. Based on obtaining the alert, process 500, via, e.g., the migration system, creates 530 a copy of the system in, e.g., a sandbox (e.g., testing environment separate from the system being debugged) in the data center, which is accessible by the on-call agent. For instance, the copy of the system is created in an environment at a region different from the region of the system being debugged and accessible to the on-call agent, based on access permissions/privileges of the on-call agent. The creation of the copy is performed, in one example, quickly (e.g., within seconds).

In one aspect, process 500, via, e.g., the migration system, mirrors 540 the live traffic of the system being debugged to a new system context that includes the copy of the system created for the debugging. Further, in one example, process 500, via, e.g., the migration system, manages 542 resources on the copy of the system. In another example, the creation of the copy of the system is performed at another stage of the process, such as after the mirroring the live traffic begins. In such a scenario, the mirrored data is stored in, e.g., a buffer so that it may be provided to the copy of the system subsequent to creation of the copy of the system.

In one example, process 500 via, e.g., the on-call agent, logs in 550 to the sandbox to perform debugging on the copy of the system. Process 500, via, e.g., the on-call agent, performs debugging 560 on the copy of the system. This includes, for instance, initiating commands, instructions, requests, tests, etc. to be executed on the copy of the system; changing the code, sequences, timing, data, etc.; performing diagnostics; etc. The debugging uses the live traffic from the system being debugged, since that traffic is mirrored to the copy. This provides real-time data from the system being debugged to the copy of the system, enabling the copy of the system to observe the issues as they occur. This real-time or live traffic is actually traffic (e.g., requests, queries, instructions, commands, etc.) received and processed by the system to be debugged.

Based on the debugging being complete, in one example, process 500 notifies 570 the migration system of the completion.

Based on obtaining an indication of completion, process 500, via, e.g., the migration system, continues to mirror 580 the live traffic to the system being debugged (e.g., the faulty production instance) but ends, in one example, mirroring of the traffic to the copy of the system. For instance, the system mirrors inbound traffic to the affected production system. As examples, the mirrored traffic can be any type of packet sent, or can be limited to specific types of packets (TCP (transmission control protocol), UDP (user datagram protocol) packets) and/or specific routes, hosts or ports. The determination can be predetermined by specific application profiles or automatically detected by observing the ongoing traffic for the affected application.

Further, in one example, process 500, via, e.g., the migration system, continues to manage 582 the resources of the system being debugged (e.g., the faulty production instance) but ends, in one example, the managing of the resources of the copy of the system.

In one example, process 500 via, e.g., the migration system, reflects 590 the changes to the system being debugged (e.g., provides a solution that may include, e.g., code fixes, tests to be run, etc.) and makes the production instance healthy. In one example, this includes providing the solution to a selected entity (e.g., an on-call agent) that provides the solution to the system being debugged. The solution is implemented in the system being debugged to provide a healthy production instance.

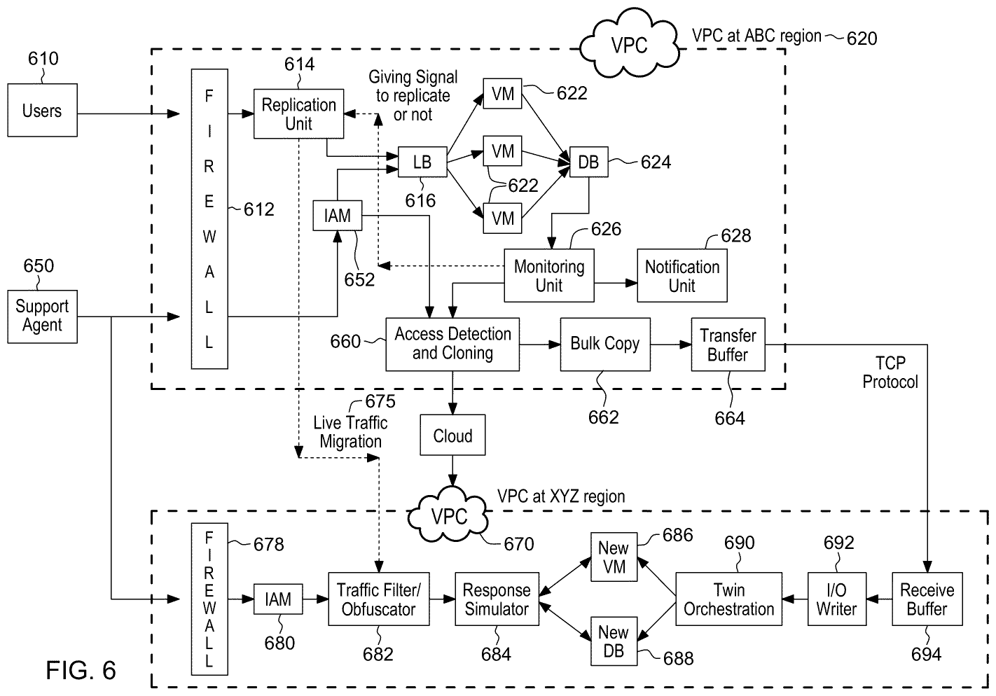

Further details related to creating a copy of a system to perform debugging are described with reference to FIG. 6, which depicts one example of a debug architecture. In one example, one or more users 610 access an environment, such as a cloud environment 620 (e.g., a virtual private cloud) at a selected region. For example, one or more users 610 access one or more virtual machines (VM) 622 in cloud environment 620 at the selected region by, e.g., passing through a firewall 612 and being routed to, e.g., a replication unit 614 which then routes the one or more users to one or more instances of the virtual machines 622. In one example, each virtual machine is a production instance or system and may be a system to be debugged, as used herein.

In one example, the replication unit uses a load balancer (LB) 616 to distribute the users (e.g., user requests) to the one or more virtual machines 622. Further, in one example, the one or more virtual machines are coupled to at least one database 624, which provides logs to a monitoring unit 626. The monitoring unit monitors the health of each virtual machine. When it is detected that a virtual machine has an issue (e.g., down, unexpected condition, unexpected result, error, etc.) as determined based on the logs (or other metrics, monitoring tools, etc.), monitoring unit 626 sends a signal to replication unit 614 to mirror the incoming traffic and also sends a notification to a support agent 650 via, e.g., a notification unit 628. In one example, replication unit 614 mirrors the data to the affected system and, in one or more aspects, mirrors the data to the copy of the system, as described herein.

In one example, based on the support agent receiving notification of an issue, the support agent attempts to connect to the system at issue (e.g., a virtual machine 622) via an identity and access management (IAM) system 652. Identity and access management system 652 checks the access privileges of the support agent (e.g., support agent 650). If the support agent has the appropriate access privileges, identity and access management system 652 allows support agent 650 to connect to the virtual machine at issue; else identity and access management system 652 redirects the flow to an access detection and cloning unit 660.

In one example, access detection and cloning unit 660 takes the access privileges that support agent 650 has and obtains (e.g., creates, is provided, employs, etc.) a new environment 670 (e.g., a virtual private cloud) at another selected region based upon the region privileges of the support agent. This provides the support agent with access to a copy of the system (e.g., a new virtual machine 686) in that region. Also, access detection and cloning unit 660 starts the process of cloning the system at issue (e.g., virtual machine 622) by performing, for instance, a bulk copy 662 of, e.g., a virtual machine disk file and sending the file via, e.g., one or more transfer buffers 664 and a TCP protocol (transmission control protocol) to one or more receive buffers 694 of the new environment 670.

In one example, a twin orchestration service 690 of environment 670 obtains the virtual machine disk file via, e.g., receive buffer(s) 694 and an input/output (I/O) writer 692 and creates a copy of the system (e.g. a digital twin of the virtual machine) in the new region. The new virtual machine 686 has all (or a selected subset) of the components as in the original instance including access to a new database 688, which is, e.g., a copy of database 624 created using, e.g., twin orchestration 690.

In one example, a traffic filter/obfuscator unit 682 receives incoming traffic 675 from, e.g., the internet sent, e.g., by the replication unit (e.g., replication unit 614). It also receives, e.g., local traffic, if any, from other nodes. Depending on the access privileges of the support agent (e.g., support agent 650) logging in via a firewall 678 and identity and access management system 680, the traffic filter service of traffic filter/obfuscator unit filters the mirrored data using data analysis and forwards the filtered data towards the new digital twin (e.g., virtual machine 686). The traffic obfuscator of traffic filter/obfuscator unit 682 automatically discovers data that it finds confidential (e.g., confidential client information) based on, e.g., the access privileges of the support agent. It acts like a person-in-middle in between the two endpoints filtering the traffic according to what is to be given to the support agent. Also, in one or more examples, traffic discovery techniques may be used.

In one example, a response simulator 684 handles interactions between the system and the copy. Response simulator 684 acts like a fake reverse proxy for outbound traffic. This service helps in response capturing so the new system (e.g., virtual machine 686) does not talk back to the internet or the production environment (e.g., environment 620). (Communication is unidirectional, in one example, from the system to the copy of the system.) A response simulator (e.g., response simulator 684) may have generic protocols. For instance, for http (hypertext transfer protocol), it may have 200 for success, 404 for not found, 400 for bad request, etc.

Taking an example—If from the internet, there is an http Get request to the faulty instance, with the simulator (e.g., response simulator 684), the Get request is mirrored to the new copy (e.g., virtual machine 686). Thus, the Get request arrives at both systems, e.g., the production virtual machine (e.g., virtual machine 622) and the copy (e.g., virtual machine 686). If the system status is acceptable, then the copy process attempts to respond to it with 200 for success. The copy responds back with, e.g., JSON (JavaScript Object Notation) data of a last system status. This response is sent to response simulator unit 684 and it gets on a virtual port and responds back with 200 ok to tell the virtual machine (e.g., virtual machine 686) that its response is received and accepted. Otherwise, the simulated system tries again and again until it eliminates the error and obtains a response of 200 success, as an example.

The above allows the copy of the system to interact with mirror traffic, including responses, allowing the support agent to diagnose and observe issues that occur due to live interaction with other services and/or users.

In one example, after debugging is complete, a cleanup process is performed and the cloned environment (e.g., environment 670) is deleted. Further, in one example, traffic mirroring and the response simulator are terminated.

In one or more examples, one or more of the components (e.g., units, modules, services, etc.) of environment 620 and environment 670 are part of the migration system described with reference to FIG. 5. For instance, the migration system may include one or more of replication unit 614, access detection and cloning 650, twin orchestration 690, etc. Other examples are possible.

Described herein is a debugging capability in which a copy of a system is created and receives live traffic to be used to debug a system having issues. An on-call agent is able to debug the system using the copy without obtaining permissions to access and without accessing the system to be debugged. This facilitates the debugging and improves system performance by improving the speed at which the debugging may commence and improving the speed at which the system is corrected.

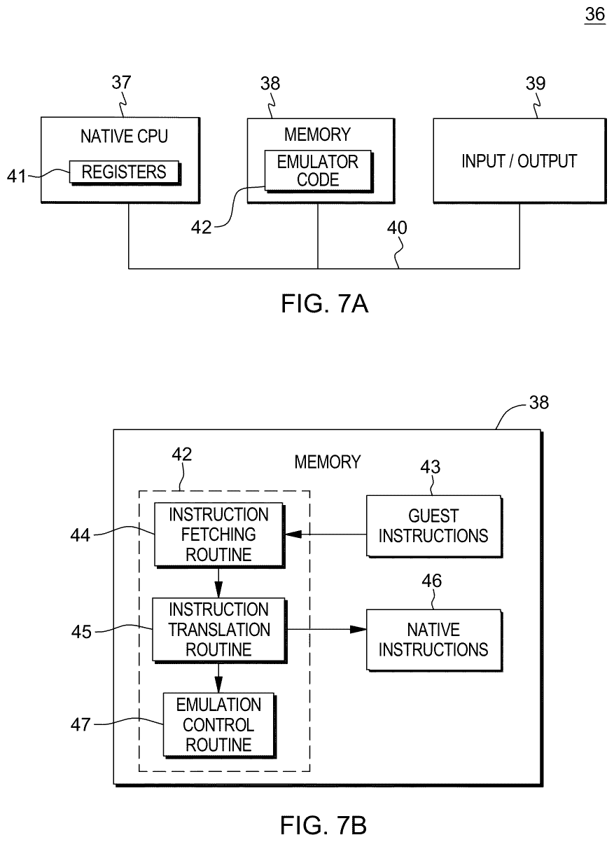

Further, although one or more examples of a computing environment to incorporate and use one or more aspects of the present disclosure are described herein, FIGS. 7A-7B depict another embodiment of a computing environment to incorporate and use one or more aspects of the present disclosure.

Referring, initially, to FIG. 7A, in this example, a computing environment 36 includes, for instance, a native central processing unit (CPU) 37 based on one architecture having one instruction set architecture, a memory 38, and one or more input/output devices and/or interfaces 39 coupled to one another via, for example, one or more buses 40 and/or other connections.

Native central processing unit 37 includes one or more native registers 41, such as one or more general purpose registers and/or one or more special purpose registers used during processing within the environment. These registers include information that represents the state of the environment at any particular point in time.

Moreover, native central processing unit 37 executes instructions and code that are stored in memory 38. In one particular example, the central processing unit executes emulator code 42 stored in memory 38. This code enables the computing environment configured in one architecture to emulate another architecture (different from the one architecture) and to execute software and instructions developed based on the other architecture.

Further details relating to emulator code 42 are described with reference to FIG. 7B. Guest instructions 43 stored in memory 38 comprise software instructions (e.g., correlating to machine instructions) that were developed to be executed in an architecture other than that of native CPU 37. For example, guest instructions 43 may have been designed to execute on a processor based on the other instruction set architecture, but instead, are being emulated on native CPU 37, which may be, for example, the one instruction set architecture. In one example, emulator code 42 includes an instruction fetching routine 44 to obtain one or more guest instructions 43 from memory 38, and to optionally provide local buffering for the instructions obtained. It also includes an instruction translation routine 45 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 42 includes an emulation control routine 47 to cause the native instructions to be executed. Emulation control routine 47 may cause native CPU 37 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 46 may include loading data into a register from memory 38; storing data back to memory from a register; or performing some type of arithmetic or logic operation, as determined by the translation routine.

Each routine is, for instance, implemented in software, which is stored in memory and executed by native central processing unit 37. In other examples, one or more of the routines or operations are implemented in firmware, hardware, software or some combination thereof. The registers of the emulated processor may be emulated using registers 41 of the native CPU or by using locations in memory 38. In embodiments, guest instructions 43, native instructions 46 and emulator code 42 may reside in the same memory or may be disbursed among different memory devices.

In one or more aspects, interactive clones (e.g., copies) of computer systems are created. Creation of the clones is based, e.g., on a support case (e.g., an issue in a system that is to have support assistance) affecting a computer system. In one example, the clone's destination is dynamically determined by what is accessible to the support agent assigned to the support case. In one example, inbound traffic to the original system is mirrored and relayed to the clone. The mirrored traffic is dynamically inspected and modified to remove and/or obfuscate confidential information determined based on, e.g., access privileges of the support agent.

In one or more aspects, a response simulation service is provisioned alongside the cloned system. The simulation service dynamically captures outbound traffic and responses from the cloned system. The simulation service provides responses either from standard templates or dynamically derived from observed traffic at the origin system.

In one or more aspects, upon completion of the support case, the created clone, traffic mirroring and response simulation are terminated and/or archived. Other examples are possible.

In one or more aspects, mirroring and relaying of inbound traffic from the origin system to the clone are provided. In one example, the mirrored traffic is dynamically inspected and modified to remove or obfuscate confidential information.

One or more aspects include creating interactive clones, dynamically determining their destinations, mirroring and modifying inbound traffic, provisioning a response simulation service, and terminating/archiving the clones. In one or more aspects, the interactive clones are created from a snapshot of the server where the issue is happening. These clones serve as replicas of the original system to be worked on.

In one or more aspects, a copy of a server is created for on-call engineers (or other on-call support agents) to efficiently debug system issues. It addresses the problem of on-call support agents needing access and waiting for permissions, proposing a solution that involves copying a snapshot of the server to a location where the on-call support agents have access. This approach reduces wait times and frustration, and allows for prompt issue resolution. Data center performance is monitored and improved using, e.g., digital twin technology.

In one or more aspects, a copy of a server is created for the purpose of debugging system issues. It addresses the challenge of granting access to on-call support agents efficiently and securely by creating a copy of the server in a location where the on-call support agents have access. The copy allows them to work on resolving the issue promptly without delays caused by permissions.

The computing environments described herein are only examples of computing environments that can be used. One or more aspects of the present disclosure may be used with many types of environments. The computing environments provided herein are only examples. Each computing environment is capable of being configured to include one or more aspects of the present disclosure. For instance, each may be configured to implement and/or perform debug processing and/or to implement and/or perform one or more other aspects of the present disclosure.

One or more aspects of the present disclosure are tied to computer technology and enhance processing within a computer, improving performance thereof. For instance, debugging is performed efficiently enabling a production environment to improve performance. Processing within a processor, computer system and/or computing environment is improved.

One or more aspects of the present disclosure may use machine learning. For instance, machine learning may be used to identify processing conditions, determine issues, determine properties and/or constraints, provide input for verification, perform analysis (including debug analysis), perform debugging and/or perform other tasks. A system is trained to perform analyses and learn from input data and/or choices made.

Machine learning (ML) solves problems that are not solved with numerical means alone. In an ML-based example, program code extracts various attributes from ML training data (e.g., historical data and/or other data collected from various data sources relevant to an event). The attributes are utilized to develop a predictor function, h(x), also referred to as a hypothesis, which the program code utilizes as a machine learning model.

The model generated by the program code is self-learning as the program code updates the model based on active event feedback, as well as from the feedback received from data related to the event. For example, when the program code determines that there is an event or pattern that was not previously predicted by the model, the program code utilizes a learning agent to update the model to reflect the state of the event, in order to improve predictions in the future. Additionally, when the program code determines that a prediction is incorrect, either based on receiving user feedback through an interface or based on monitoring related to the event, the program code updates the model to reflect the inaccuracy of the prediction for the given period of time. Program code comprising a learning agent cognitively analyzes the data deviating from the modeled expectations and adjusts the model to increase the accuracy of the model, moving forward.

In one or more embodiments, program code, executing on one or more processors, utilizes an existing cognitive analysis tool or agent (now known or later developed) to tune the model, based on data obtained from one or more data sources. In one or more embodiments, the program code interfaces with application programming interfaces to perform a cognitive analysis of obtained data. Specifically, in one or more embodiments, certain application programming interfaces comprise a cognitive agent (e.g., learning agent) that includes one or more programs, including, but not limited to, natural language classifiers, a retrieve and rank service that can surface the most relevant information from a collection of documents, concepts/visual insights, trade off analytics, document conversion, and/or relationship extraction. In an embodiment, one or more programs analyze the data obtained by the program code across various sources utilizing one or more of a natural language classifier, retrieve and rank application programming interfaces, and trade off analytics application programming interfaces. An application programming interface can also provide audio related application programming interface services, in the event that the collected data includes audio, which can be utilized by the program code, including but not limited to natural language processing, text to speech capabilities, and/or translation.

In one or more embodiments, the program code utilizes a neural network to analyze event-related data to generate the model utilized to predict the state of a given event at a given time. Neural networks are biologically-inspired programming paradigms, which enable a computer to learn and solve artificial intelligence problems. This learning is referred to as deep learning, which is a subset of machine learning, an aspect of artificial intelligence, and includes a set of techniques for learning in neural networks. Neural networks, including modular neural networks, are capable of pattern recognition with speed, accuracy, and efficiency, in situations where data sets are multiple and expansive, including across a distributed network, including but not limited to, cloud computing systems. Modern neural networks are non-linear statistical data modeling tools. They are usually used to model complex relationships between inputs and outputs or to identify patterns in data (i.e., neural networks are non-linear statistical data modeling or decision making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in multiple source processing, which the program code in one or more embodiments accomplishes when obtaining data and generating a model for predicting states of a given event.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

Yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other copying and/or cloning techniques may be used. Many variations are possible.

Various aspects and embodiments are described herein. Further, many variations are possible without departing from a spirit of one or more aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of facilitating processing within a computing environment, the computer-implemented method comprising:
creating a copy of a system within a selected region, the selected region being different from a region that includes the system and wherein the selected region is obtained for the copy of the system based on one or more privileges of a support agent to be used to debug the system;
obtaining at the copy of the system real-time data of the system, the real-time data migrated from the system to the copy of the system, the copy of the system and the real-time data migrated from the system to be used to debug the system;
performing debugging processing using the copy of the system and the real-time data migrated from the system to generate a debug solution for the system; and
providing the debug solution to a selected entity.

2. The computer-implemented method of claim 1, further comprising obfuscating at least a portion of the real-time data to obscure confidential data in the real-time data to provide obfuscated data, and wherein the performing the debugging processing uses the obfuscated data.

3. The computer-implemented method of claim 2, wherein the obfuscating is based on the one or more privileges of the support agent.

4. The computer-implemented method of claim 1, wherein the creating the copy of the system is initiated based on detecting inaccessibility of the support agent to the system.

5. The computer-implemented method of claim 1, wherein the performing debugging processing includes generating one or more responses to one or more queries of the real-time data migrated from the system, the one or more responses being provided to the copy of the system.

6. The computer-implemented method of claim 5, further comprising performing clean-up based on providing the debug solution, wherein the performing clean-up includes terminating generation of responses.

7. The computer-implemented method of claim 1, further comprising performing clean-up based on providing the debug solution.

8. The computer-implemented method of claim 7, wherein the performing clean-up includes deleting the copy of the system.

9. The computer-implemented method of claim 7, wherein the performing clean-up includes terminating migrating the real-time data to the copy of the system.

10. The computer-implemented method of claim 1, wherein a flow of information between the system and the copy of the system is unidirectional from the system to the copy of the system.

11. The computer-implemented method of claim 1, wherein the system is a virtual machine and the copy of the system is another virtual machine created using digital twin orchestration.

12. A computer system for facilitating processing within a computing environment, the computer system comprising:
at least one computing device;
a set of one or more computer readable storage media; and
program instructions, collectively stored in the set of one or more computer readable storage media, for causing the at least one computing device to perform the following computer operations including:
creating a copy of a system within a selected region, the selected region being different from a region that includes the system and wherein the selected region is obtained for the copy of the system based on one or more privileges of a support agent to be used to debug the system;
obtaining at the copy of the system real-time data of the system, the real-time data migrated from the system to the copy of the system, the copy of the system and the real-time data migrated from the system to be used to debug the system;
performing debugging processing using the copy of the system and the real-time data migrated from the system to generate a debug solution for the system; and
providing the debug solution to a selected entity.

13. The computer system of claim 12, wherein the computer operations further comprise obfuscating at least a portion of the real-time data to obscure confidential data in the real-time data to provide obfuscated data, and wherein the performing the debugging processing uses the obfuscated data.

14. The computer system of claim 12, wherein the creating the copy of the system is initiated based on detecting inaccessibility of the support agent to the system.

15. The computer system of claim 12, wherein a flow of information between the system and the copy of the system is unidirectional from the system to the copy of the system.

16. A computer program product for facilitating processing within a computing environment, the computer program product comprising:
a set of one or more computer readable storage media; and
program instructions, collectively stored in the set of one or more computer readable storage media, for causing at least one computing device to perform the following computer operations including:
creating a copy of a system within a selected region, the selected region being different from a region that includes the system and wherein the selected region is obtained for the copy of the system based on one or more privileges of a support agent to be used to debug the system;
obtaining at the copy of the system real-time data of the system, the real-time data migrated from the system to the copy of the system, the copy of the system and the real-time data migrated from the system to be used to debug the system;
performing debugging processing using the copy of the system and the real-time data migrated from the system to generate a debug solution for the system; and
providing the debug solution to a selected entity.

17. The computer program product of claim 16, wherein the computer operations further comprise obfuscating at least a portion of the real-time data to obscure confidential data in the real-time data to provide obfuscated data, and wherein the performing the debugging processing uses the obfuscated data.

18. The computer program product of claim 16, wherein the creating the copy of the system is initiated based on detecting inaccessibility of the support agent to the system.

19. The computer program product of claim 16, wherein the performing debugging processing includes generating one or more responses to one or more queries of the real-time data migrated from the system, the one or more responses being provided to the copy of the system.

20. The computer program product of claim 16, wherein a flow of information between the system and the copy of the system is unidirectional from the system to the copy of the system.
